(19) United States
(12) Patent Application Publication
(10) Pub. No.: US 2015/0264960 A1
(43) Pub. Date: Sep. 24, 2015

(54) Pet Beverage and Container

(71) Applicant: John P. Flavin, Pittsburgh, PA (US)

(72) Inventor: John P. Flavin, Pittsburgh, PA (US)

(21) Appl. No.: 14/656,971

(22) Filed: Mar. 13, 2015

Related U.S. Application Data
(60) Provisional application No. 61/968,656, filed on Mar. 21, 2014.

(51) Int. Cl. A23K 1/175; A23K 1/14; B65D 85/72; B65D 1/02; B65D 43/16; B65D 51/18; A23K 1/10; A23K 1/16

(52) U.S. Cl. CPC A23K 1/175; A23K 1/10; A23K 1/14; A23K 1/1603; A23K 1/1751; A23K 1/1753; A23K 1/1755; B65D 1/023; B65D 43/16; B65D 51/18; B65D 85/72; A23V 2002/00; B65D 2251/0021; B65D 2251/0028; B65D 2251/009; B65D 2543/00074

(57) ABSTRACT

An aqueous beverage for a dog made from fruit, vegetable, and/or meat juices combined with premeasured quantities of electrolytes. In some embodiments, the beverage includes premeasured quantities of sugars and/or water soluble vitamins and minerals. The beverage is stored and served in an improved container having a concave shaped lid hingeably affixed to the container. When the lid is in an open position, the beverage is poured into the lid, whose interior side is a bowl, raised above the ground by the container, from which the dog drinks the beverage.

### CROSS REFERENCE TO RELATED APPLICATION

Reference is made to and priority claimed from U.S. provisional application Ser. No. 61/968,656 filed on 21 Mar. 2014.

### TECHNICAL FIELD

The present invention pertains to the field of pet nutrition and accessories. More particularly, the present invention pertains to liquid nutritional supplements for dogs in the form of bottled beverages and an improved reusable bottle and bowl for the bottled beverage.

### BACKGROUND OF THE INVENTION

Nutritionists have long known that dogs, like humans, benefit from nutritionally complete diets. Essential vitamins for dogs include vitamins A, D, E, and K, which are stored in a dog's body fat, and water soluble B vitamins. Water soluble vitamin C is also beneficial to dogs, but can be manufactured by a healthy dog's own body. Essential minerals include calcium and phosphorus for bone formation and strength, magnesium for healthy metabolic, cardiovascular, muscle, and nervous system functioning, and salts such as sodium chloride and potassium for proper cellular functioning. Dog foods are commonly fortified with the aforesaid vitamins and minerals, but to varying degrees, and additionally some dogs require special or supplemental vitamins and minerals in their diets due to underlying medical conditions, an inability to absorb nutrients from food due to age, or to supplement an otherwise healthy dog's normal food and drink due to the dog's increased physical activity.

Currently, dog owners provide their dogs with supplements in pill or concentrated liquid form. Both types of supplements are normally added to the dog's food, or forced down the dog's throat. The inventor is a dog owner, and has experienced his dog rejecting food altered by the addition of a supplement not normally found in the food, as well as the unpleasant struggle of forcing his dog to swallow pills or other necessary supplements.

What is needed is a simple way to improve or enhance the diet of a dog using tasty drinks fortified with vitamins and minerals needed by the dog, for the purpose of treating a medical condition, or just for enhancing a healthy dog's diet.

The inventor also regularly walks his dog, and dislikes the inconvenience of carrying both a water bottle and a bowl in order to provide his dog with liquids while away from home. Dogs can learn to drink out of water bottles, but the process is messy and wastes a great deal of water.

What is also needed is a convenient liquid container capable of both storing and then serving the liquid contained therein.

### DISCLOSURE OF INVENTION

The invention of the first part is a flavored beverage for dogs fortified with a mix of desired vitamins, minerals, and other supplements to aid in dog nutrition and health. The flavored beverage is administered to the dog in addition to, or in lieu of, water, and in one embodiment, the flavored beverage is administered to the dog according to the dog's weight, and in another embodiment, the flavored beverage can be given in lieu of water and without restriction.

The invention of the second part is a portable container with a hinged domed lid, the lid forming a serving bowl into which the liquid stored inside the portable container can be dispensed and then conveniently served to the dog.

### BRIEF DESCRIPTION OF THE DRAWINGS

The features and advantages of the invention will become apparent from a consideration of the subsequent detailed description presented in connection with accompanying drawings, in which:

FIG. 1 is a chart showing a typical ingredient composition of one embodiment of an aqueous beverage for a dog.

FIG. 1a is a chart showing an electrolyte composition in a blood sample from a healthy dog (PRIOR ART).

FIGS. 2a and 2b are side elevation, cross-sectional views of a portable container for holding and serving liquids, FIG. 2a showing the container with a lid in an open or serving position, and FIG. 2b showing the container with the lid in a closed or storage position.

### DRAWINGS LIST OF REFERENCE NUMERALS

The following is a list of reference labels used in the drawings to label components of different embodiments of the invention, and the names of the indicated components.

10 pet beverage

12 fruit and/or vegetable

14 water and/or other liquid

20 container

22 container portion

24 hollow interior portion

26 top end

28 neck

30 lid

32 storage or closed position

34 interior side of lid

36 serving position

38 hinge

40 cap

41 tab

### DETAILED DESCRIPTION

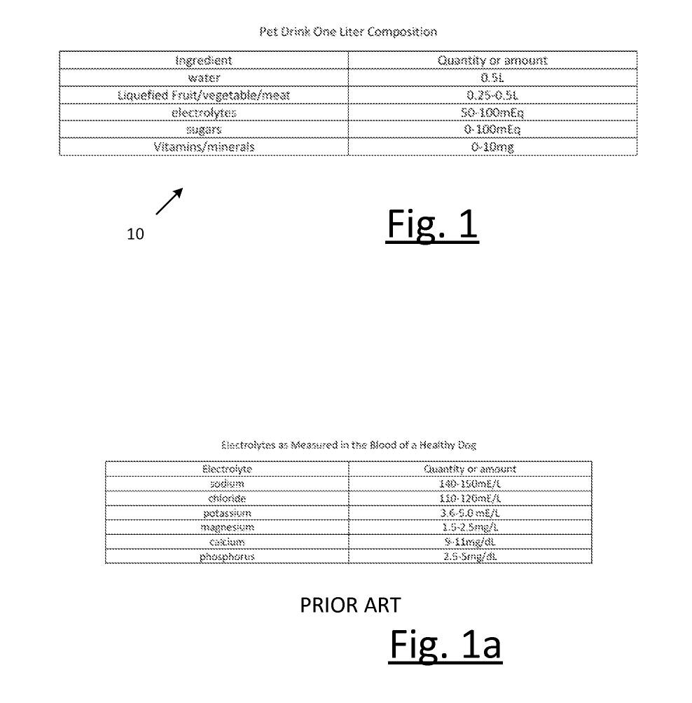

A beverage according to the invention is an aqueous beverage 10 shown in a typical formulation in FIG. 1, and as compared to an electrolyte composition of a sample of blood taken from a healthy dog shown in FIG. 1a. In a typical recipe, using the formulation shown in FIG. 1, the beverage 10 is formulated using 0.5L of pulverized apples mixed with 0.5L of water to create a total liquid volume of 1L. Water soluble vitamins and minerals, such as calcium, and vitamins B and C are added up to 10 mg/L. An electrolyte solution of 45 mEq sodium, 20 mEq of potassium, 35 mEq of chloride, and 8 mg of zinc is added. In an advantageous embodiment, a measured quantity of sugar appropriate for dogs in the form of glucose, dextrose, or fructose is added to the beverage 10, such as 25-30mg of glucose.

In the formulation described in FIG. 1 it should be noted that other suitable fruits and vegetables can be substituted for the apples, or added in addition to the quantity of apples. Bananas, watermelon, oranges, carrots, green beans, zucchini, and cucumbers may be used. Some, but not all fruits and vegetables, can be safely ingested by a plurality of dogs despite the fact that dogs are normally carnivorous and not normally adapted to ingesting foods other than meat and liquids other than water. The ratio of fruit/vegetables to water is typically 1:1 however in other embodiments, the ratio of fruit/vegetables to water can vary considerably, depending on whether the beverage is provided as a liquid or as a frozen concentrate to which water is later added after thawing. In some cases, a partially thawed concentrate can be provided to the dog as a slush-like treat on a hot day, much like a snow cone for a dog, and in these cases, the fruit/vegetable to water ratio may range from 1:1 to 3:1. For a healthy dog with no known medical conditions requiring supplements, a fruit and/or vegetable based beverage such as the one described in FIG. 1 can be safely provided to the dog to enhance the dog's health by introducing vitamins, minerals, antioxidants, and simple sugars to the dog in a pleasant and natural manner by substituting the beverage for plain water. As the vitamins and minerals are water soluble, the beverage can be safely provided on demand, and it should be noted that the beverage 10 can be made with just electrolytes without glucose or added vitamins and minerals, or other variations, such as electrolytes with vitamins but no minerals and no glucose, or electrolytes with glucose but no added vitamins and minerals. For active dogs in particular, the beverage 10 can safely and quickly replenish glucose levels in a tired dog.

The inventor also notes that dogs enjoy meat flavors, and meat broths may be substituted or used in addition to fruits and/or vegetables. In particular, one formulation of the beverage 10 shown is made without added sugars and uses a meat and/or vegetable flavored broth for a savory beverage.

In the case of fat-soluble essential vitamins A, D, E, and K, these can also be added to the beverage 10 in amounts appropriate for dogs however the quantity of beverage provided that the dog's ingestion is monitored and the beverage 10 is provided according to the dog's weight, age and general health. As these vitamins are stored in the body, allowing the dog unrestricted access to the beverage 10 enhanced with these vitamins may be dangerous.

The inventor also notes that the beverage 10 could also be provided as a frozen concentrate that is then mixed with an appropriate amount of water before providing the beverage 10 to the dog. As a frozen concentrate, the vitamins and antioxidants present in the fresh fruit/vegetables would not be lost by heat processing, and additionally, the dog would be treated with a nice cool refreshing beverage! In yet another advantageous embodiment, the frozen concentrate could be mixed with ice cubes in a blender, to make a frozen slushy treat for the dog with no known ailments or dietary restrictions.

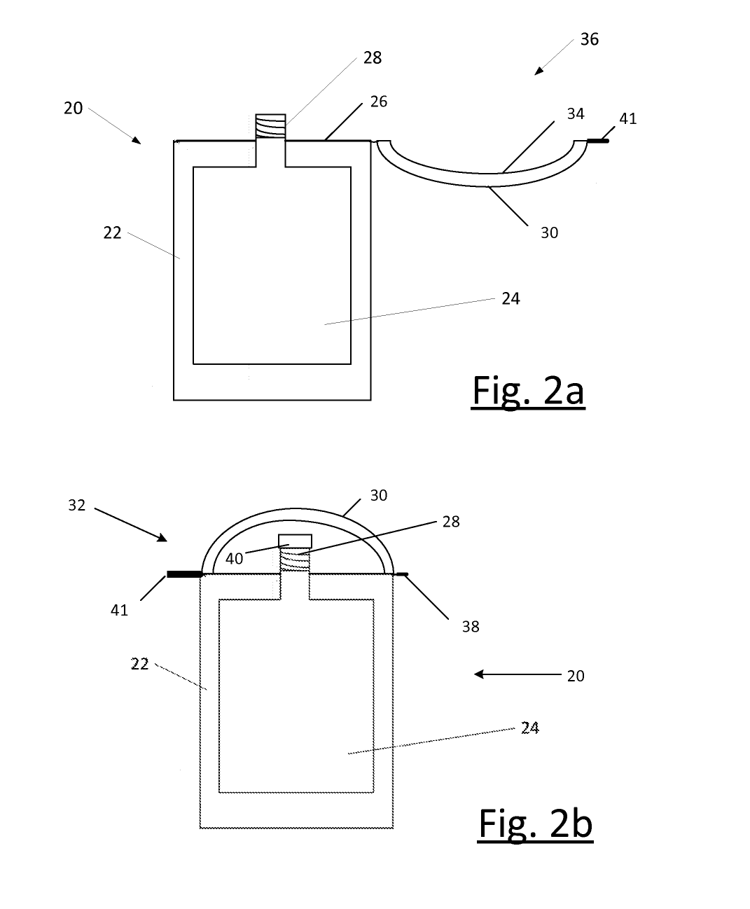

A container according to the invention 20 is described in FIGS. 2a and 2b. The container portion 22 is provided typically as generally cylindrical, with a hollow interior portion 24 for storing a quantity of potable liquid, ideally such as the beverage described in FIGS. 1 and/or 1a or some other potable liquid such as water. A top end 26 of the container is formed with an annular neck 28 leading to the interior hollow portion 24 of the container portion 22. A removable cap 40 is fitted to insert into the neck 28 or alternatively, to fit over the neck 28 so as to securely seal the inner portion 24. A lid 30 is hingeably affixed to the top end 26 of the container portion 22 by a hinge 38, typically comprised of a flexible piece of silicone, plastic or other suitable material that is attached to the container at one end and to the lid at an other end. The lid 30 formed as a convex or domed shape such that when the lid 30 is in a closed or storage position 32, as shown in FIG. 2b, the lid 30 fits over the cap 40 and neck 28. A tab 41 is formed on the lid so as to allow easy opening and closing of the lid. When the lid 30 is removed by pivoting the lid away from the neck 28 (by grasping the tab 41), as shown in FIG. 2a, the interior side 34 of the lid 30 is now in a serving position 36, forming a bowl. In a preferred embodiment, measuring lines are formed or printed on the inside of the lid to allow a user to accurately measure a desired amount of liquid poured into the lid 30.

In use, a desired quantity of liquid is poured into the container according to the invention 20 and the neck 28 is sealed by the cap 40. The lid 30 is pivoted to cover the cap 40. In some embodiments, the lid 30 rests against the top end 26 of the container portion 22, in other embodiments, the lid in the closed position 32 is secured to the container portion by a variety of securing means, such as tabs or with mating members formed into the lid and the container portion. When a user wants to provide a beverage to a dog, the user holds the container portion 22 in one hand, pivots the lid 30 into an open or serving position, removes the cap 40, and tilts the container portion 22 until a desired quantity of beverage pours into the opened lid 30. The user then either holds the container or positions the container on a level surface, and the dog drinks from the opened lid that is now serving as a bowl.

The container according to the invention 20 has many ergonomic benefits for the dog, including raising the level of the drinking bowl so the dog does not have to lower its neck all the way to the ground. This is known to be helpful for large dogs, as well as older dogs who may have arthritis or other conditions and find elevated drinking bowls to be more comfortable. The combined container-bowl according to the invention 20 is also convenient for the user, who has a single, dual use container that is sleeker and easier to carry and stow. All the necessary pieces cannot be lost or misplaced because they are attached to the container 20. In some embodiments, the container 20 includes a strap or other means for hands free carrying. In some embodiments, the container portion 22 is provided as a wide cylinder, such that the diameter of the cylinder is greater than the height, so as to prevent the container from tipping over when the lid is in serving position 36, and also to provide a larger serving bowl suitable for a larger dog, or to allow multiple dogs to drink from a single bowl at the same time.

It is to be understood that the above-described arrangements are only illustrative of the application of the principles of the present inventions. Numerous modifications and alternative arrangements may be devised by those skilled in the art without departing from the scope of the present invention. For instance, the dog beverage described in FIG. 1 can be made in multiple ways, for instance, by blending vegetables and fruit with meat-flavors to create refreshing and tasty beverages that resemble thin soups for dogs. Fruit/vegetable to water ratios can also be changed to incorporate more fruit/vegetable or more water, as desired, and water can be added to make up the beverage volume to 1L. In cases where the beverage is designed to treat dogs with specific dietary needs, the ratio of supplements to fruit/vegetable to water is measured according to the dog's age and weight. In these cases, fat soluble essential vitamins A, D, E, and K are added in measured amounts and the beverage is provided to the dog in amounts relating to the dog's weight and age.

What is claimed is:

1. A beverage (10) for a dog wherein one liter of the beverage is comprised of an aqueous solution including a quantity of at least one electrolyte selected from the group consisting of sodium, chloride, potassium, magnesium, calcium and phosphorus, and further including a quantity of juice derived from at least one of fruit, vegetable, and meat.

2. The beverage (10) in claim 1 wherein the beverage is further comprised of a sugar selected from glucose, dextrose, and fructose, in a concentration of up to 30 grams.

3. The beverage (10) of claim 1, wherein the quantity of electrolyte includes 45 mEq of sodium.

4. The beverage (10) of claim 3, wherein the quantity of electrolyte includes 15-25 mEq of potassium.

5. The beverage (10) of claim 3, wherein the quantity of electrolyte includes 25-25 mEq of chloride.

6. The beverage (10) of claim 1, further comprising water-soluble vitamins selected from B-vitamins and vitamin C.

7. The beverage (10) of claim 1, wherein the quantity of juice included is 0.25-0.5L of at least one of beef, chicken, and lamb broth.

8. The beverage (10) of claim 1, wherein the quantity of juice include is 0.25-0.5L of apple juice.

9. A container (20) for storing and serving the beverage (10) of claim 1, the container comprising:
a container portion (22) having an internal storage area (24) accessed via a hollow cylindrical neck (28) formed at a top end (26) of the container portion (22);
a lid (30) hingeably affixed to the top end (26) of the container portion (22) and having an interior side (34); and
a cap (40) removably affixed to an uppermost end of the neck (28);
wherein the lid (30) is positionable in at least one of a closed (32) and an open (36) position; and
wherein in the open position, the interior side (34) of the lid is a bowl;
whereby a quantity of the beverage (10) stored inside the internal storage space (24) of the container is poured into the interior side (34) of the lid.
